(19) United States
(12) Patent Application Publication
(10) Pub. No.: US 2022/0018263 A1
(43) Pub. Date: Jan. 20, 2022

(54) Stator Blade Heating System, Steam Turbine Having Stator Blade Heating System, Stator Blade Segment, and Stator Blade Heating Method

(71) Applicant: Mitsubishi Power, Ltd., Yokohama-shi (JP)

(72) Inventors: Yurika SEO, Yokohama-shi (JP); Yasuhiro SASAO, Yokohama-shi (JP); Takeshi KUDO, Yokohama-shi (JP)

(21) Appl. No.: 17/375,200

(22) Filed: Jul. 14, 2021

(30) Foreign Application Priority Data
Jul. 17, 2020 (JP) 2020-123181

(51) Int. Cl. F01D 25/10

(52) U.S. Cl. CPC F01D 25/10; F05D 2260/20; F05D 2220/31

(57) ABSTRACT

A stator blade heating system is to heat a hollow stator blade of a steam turbine, and includes: an electromagnetic coil disposed within a hollow portion of the stator blade; and a heating device electrically connected to the electromagnetic coil and capable of supplying an alternating current to the electromagnetic coil. A core wound with the electromagnetic coil is disposed within the hollow portion of the stator blade. The stator blade heating system further includes a regulator that regulates output of the alternating current of the heating device, and a temperature sensor that detects temperature of the stator blade. The regulator regulates the output of the heating device on the basis of the temperature detected by the temperature sensor.

### BACKGROUND OF THE INVENTION

### 1. Field of the Invention

The present invention relates to a stator blade heating system used for a steam turbine, a steam turbine having the stator blade heating system, a stator blade segment used for a steam turbine, and a stator blade heating method used for a steam turbine.

### 2. Description of the Related Art

In a steam turbine used in a nuclear power plant, a thermal power plant, or the like, cascades of stator blades and rotor blades are arranged alternately, and constitute a plurality of turbine stages. Steam at a high temperature and a high pressure as a working fluid of the steam turbine is rectified by the cascades of stator blades, and rotation-drives a rotor including the cascades of rotor blades.

This steam decreases in temperature and pressure each time the steam passes through a turbine stage. The steam is in a state of wet steam containing minute waterdrops in a low-pressure turbine stage. Many of the minute waterdrops pass between the blades of the cascades together with the steam. However, a part of the minute waterdrops adhere to the blade surfaces of stator blades. In addition, on a part at a lower temperature than the wet steam in the blade surfaces of the stator blades, waterdrops may be generated by condensation of the steam due to supercooling. Such waterdrops on the blade surfaces of the stator blades are accumulated, and thereby form a liquid film. When the liquid film moves to the vicinity of the trailing edges of the stator blades by the flow of the steam and scatters into the flow of the steam, the liquid film may flow down as a large waterdrop. This large waterdrop is known to cause erosion on the surfaces of rotor blades rotating at high speed and a stationary member on the downstream side of the stator blades by colliding with the rotor blades and the stationary member.

As a method for suppressing surface erosion of the rotor blades, a structure is known in which slits are provided on the blade surface of a stator blade having a hollow structure so as to communicate with a stator blade hollow portion (see JP-2015-7379-A, for example). A liquid film formed on the blade surface of the stator blade is removed by being sucked via the slits into the stator blade hollow portion, which communicates with an exhaust chamber or the like and is at a relatively low pressure.

In addition, another method for suppressing surface erosion of the rotor blades is known to heat a stator blade itself by allowing high temperature steam to circulate in a hollow portion of the stator blade having a hollow structure (see JP-1998-103008-A, for example). In the method of heating the stator blade of the steam turbine as described in JP-1998-103008-A, leak steam at a high temperature and a low pressure, which is extracted from a shaft sealing packing on a high-pressure side of the steam turbine, is allowed to flow through the stator blade hollow portion, is thereby used to heat the stator blade, and is thereafter released to a low-pressure stage of the steam turbine.

In a case in which erosion of the rotor blades or the like is to be suppressed by providing slits on the blade surface of the stator blade having a hollow structure as in the technology described in JP-2015-7379-A, a drill or electric discharge machining is generally used for slit processing of a blade material. Thus, processing accuracy is low and cost tends to be high. Further, there is also a problem of less flexibility in arrangement of the slits. This is because the slits need to be arranged intermittently due to a problem in strength of the stator blade. In addition, it is difficult to process the slits on a thin portion in the vicinity of the trailing edge of the stator blade. From the above, there is a need for easier manufacturing of the stator blades.

In a case in which erosion of the rotor blades or the like is to be suppressed by heating the stator blades with high temperature steam as in the technology described in JP-1998-103008-A, large-scale equipment for supplying steam to the stator blades is necessary. For example, the technology described in JP-1998-103008-A necessitates a leak steam supply line from the shaft sealing packing on the high-pressure side of the steam turbine to the stator blades in a low-pressure stage and a control valve disposed on the line. In addition, the temperature and flow rate of the steam as a heating source depend on a supply source of the steam. Hence, in order to supply the stator blades with heated steam at a fixed temperature and a fixed flow rate, consideration needs to be given to securing an appropriate supply source, maintaining the temperature of piping, and the like. These may invite complication of the system. Depending on the secured supply source, equipment for adjusting the steam temperature may be necessary. This may invite further complication of the system.

The present invention has been made to solve the above-described problems. It is an object of the present invention to provide a stator blade heating system, a steam turbine having the stator blade heating system, a stator blade segment used for a steam turbine, and a stator blade heating method that can facilitate the manufacturing of a stator blade and suppress erosion without using large-scale equipment.

### SUMMARY OF THE INVENTION

The present application includes a plurality of means for solving the above-described problems. To cite an example of the means, there is provided a stator blade heating system for heating a hollow stator blade of a steam turbine. The stator blade heating system includes: an electromagnetic coil disposed within a hollow portion of the stator blade; and a heating device electrically connected to the electromagnetic coil and capable of supplying an alternating current to the electromagnetic coil.

According to the present invention, the stator blade can be heated by an eddy current induced by supplying a high frequency current to the electromagnetic coil disposed within the hollow portion of the stator blade. It is therefore possible to evaporate waterdrops on the blade surface of the stator blade, and prevent waterdrops from being generated on the blade surface due to the condensation of the steam. In this case, structures for removing waterdrops such as slits or the like do not need to be processed on the stator blade having a hollow shape, and there is no need for large-scale equipment for supplying heated steam to the hollow portion of the stator blade. That is, it is possible to facilitate the manufacturing of the stator blade, and suppress erosion without using large-scale equipment.

Problems, configurations, and effects other than those described above will be made apparent by the following description of embodiments.

### BRIEF DESCRIPTION OF THE DRAWINGS

FIG. 1 is a schematic longitudinal sectional view showing a steam turbine having a stator blade heating system according to one embodiment of the present invention;

FIG. 2 is a schematic front view showing a nozzle diaphragm constituting a part of the steam turbine according to one embodiment of the present invention, the steam turbine being shown in FIG. 1;

FIG. 3 is a schematic diagram showing a configuration of the stator blade heating system according to one embodiment of the present invention and showing a structure of a stator blade constituting a part of the steam turbine;

FIG. 4 is a schematic sectional view of the stator blade constituting a part of the steam turbine according to one embodiment of the present invention as viewed from the direction of arrows IV-IV shown in FIG. 3;

FIG. 5 is a block diagram showing functions of a regulator constituting a part of the stator blade heating system according to one embodiment of the present invention, the stator blade heating system being shown in FIG. 3; and

FIG. 6 is a flowchart illustrating an example of a procedure for temperature control by the regulator constituting a part of the stator blade heating system according to one embodiment of the present invention, the regulator being shown in FIG. 5.

### DESCRIPTION OF THE PREFERRED EMBODIMENTS

Referring to the drawings, description will hereinafter be made of a stator blade heating system, a steam turbine having the stator blade heating system, a stator blade segment used in the steam turbine, and a method of heating stator blades of the steam turbine according to an embodiment of the present invention. The present embodiment illustrates an example of application to a low-pressure turbine.

### One Embodiment

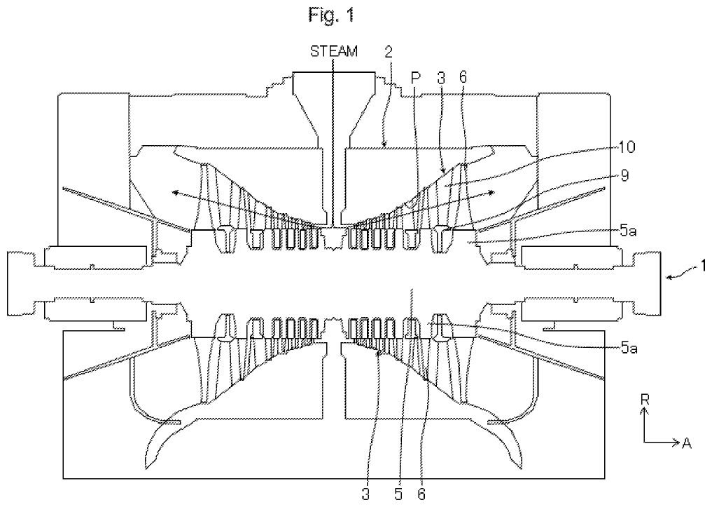

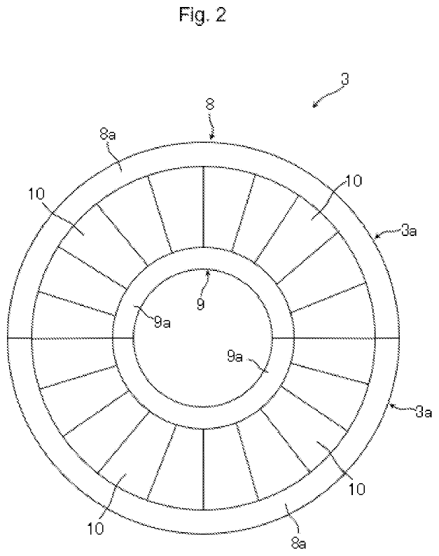

A configuration of a steam turbine having a stator blade heating system according to one embodiment of the present invention will first be described with reference to FIG. 1 and FIG. 2. FIG. 1 is a schematic longitudinal sectional view showing a steam turbine having a stator blade heating system according to one embodiment of the present invention. FIG. 2 is a schematic front view showing a nozzle diaphragm constituting a part of the steam turbine according to one embodiment of the present invention, the steam turbine being shown in FIG. 1. In FIG. 1, A denotes an axial direction, and R denotes a radial direction.

In FIG. 1, the steam turbine is, for example, of a double flow exhaust type in which two low-pressure turbines are combined in tandem with each other, and a steam inlet is at a central portion in the axial direction and steam outlets are at both end portions in the axial direction. The steam turbine includes a turbine rotor 1 supported rotatably about an axis and a casing 2 that covers the turbine rotor 1 from the outside.

The turbine rotor 1 includes: a rotor shaft 5 with a plurality of wheel portions 5a (six wheel portions 5a in FIG. 1) arranged at intervals in the axial direction A; and a plurality of rotor blades 6 attached to an outer circumferential portion of each wheel portion 5a of the rotor shaft 5 at intervals in a circumferential direction. The plurality of rotor blades 6 arranged in the circumferential direction on the wheel portion 5a constitute a rotor cascade.

As shown in FIGS. 1 and 2, on an inner circumferential side of the casing 2, annular nozzle diaphragms 3 are attached so as to be arranged alternately with cascades of rotor blades 6 at intervals in the axial direction. As shown in FIG. 2, each nozzle diaphragm 3 is formed by coupling a plurality of stator blades 10 arranged at intervals in the circumferential direction to each other. The plurality of stator blades 10 of each nozzle diaphragm 3 constitute a stator cascade. As shown in FIG. 1, the cascade of the stator blades 10 of each nozzle diaphragm 3 is opposed, on an upstream side of a flow (thick arrow) of steam (working fluid), to a cascade of rotor blades 6. The cascade of the stator blades 10 constitutes one turbine stage in combination with the cascade of the rotor blades 6. Each low-pressure turbine of the steam turbine shown in FIG. 1, for example, has six turbine stages.

As shown in FIG. 2, for example, each nozzle diaphragm 3 includes: an annular outer ring 8 attached to the casing 2; an annular inner ring 9 located on the inner circumferential side of the outer ring 8; and a plurality of stator blades 10 provided so as to be arranged at intervals in the circumferential direction between the outer ring 8 and the inner ring 9. For the convenience of assembly, each nozzle diaphragm 3 is divided in the circumferential direction as a plurality of stator blade segments 3a. That is, each stator blade segment 3a is one of a plurality of structures into which the nozzle diaphragm 3 is divided in the circumferential direction. The nozzle diaphragm 3 shown in FIG. 2 is divided into a stator blade segment 3a as a lower half section and a stator blade segment 3a as an upper half section. The stator blade segment 3a includes a plurality of stator blades 10, an arcuate divided outer ring portion 8a coupling radially outer end portions of the plurality of stator blades 10 to each other, and an arcuate divided inner ring portion 9a coupling radially inner end portions of the plurality of stator blades 10 to each other.

As shown in FIG. 1, an annular flow passage P through which steam flows is defined by the outer circumferential surface of the rotor shaft 5, an inner circumferential portion of the casing 2, and the inner rings 9 and the outer rings 8 of the nozzle diaphragms 3. The cascades of the stator blades 10 and the cascades of the rotor blades 6 are arranged within the annular flow passage P.

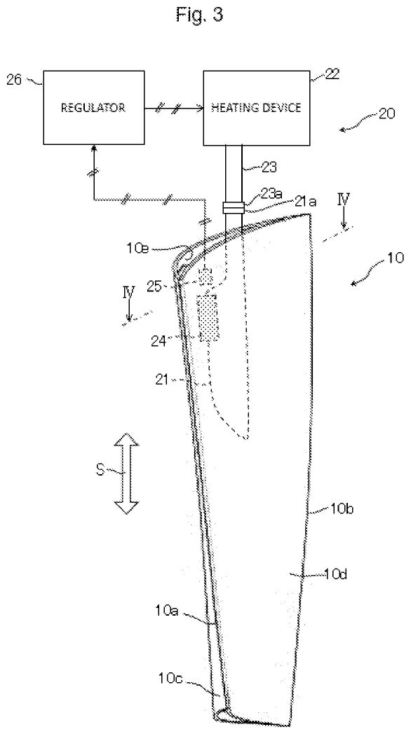

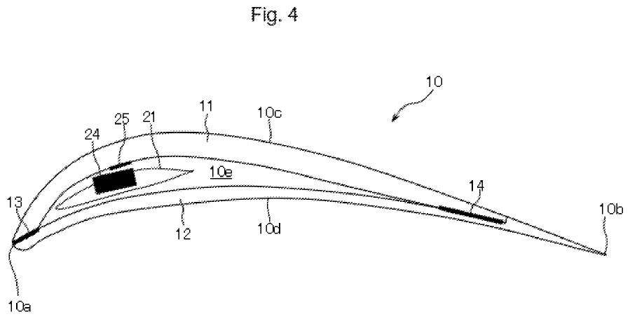

Referring to FIG. 3 and FIG. 4, description will next be made of a structure of a stator blade constituting a part of a stator blade segment and a configuration of the stator blade heating system according to one embodiment of the present invention. FIG. 3 is a schematic diagram showing a configuration of the stator blade heating system according to one embodiment of the present invention and showing a structure of a stator blade constituting a part of the steam turbine. FIG. 4 is a schematic sectional view of the stator blade constituting a part of the steam turbine according to one embodiment of the present invention as viewed from the direction of arrows IV-IV in FIG. 3.

As shown in FIG. 3 and FIG. 4, the stator blade 10 is a metallic member (conductor) whose cross section orthogonal to a span direction S of the stator blade 10 (radial direction of the steam turbine) is formed in a hollow airfoil shape. That is, the stator blade 10 internally has a hollow portion 10e. The blade surface of the stator blade 10 includes: a leading edge 10a as an edge on an upstream side in a flow direction of steam; a trailing edge 10b as an edge on a downstream side; a convex suction surface 10c which extends on a suction side between the leading edge 10a and the trailing edge 10b; and a concave pressure surface 10d which extends on a pressure side between the leading edge 10a and the trailing edge 10b.

In the stator blade 10, as shown in FIG. 4, for example, a first metal plate 11 processed in a curved shape and a second metal plate 12 processed in a curved shape are joined together via a first joining portion 13 and a second joining portion 14, and thereby forming a airfoil shape while forming an internal space 10e between the first metal plate 11 and the second metal plate 12. The first metal plate 11 is formed such that the external surface of the first metal plate 11 constitutes a large part of the suction surface 10c on the suction side which extends from the leading edge 10a to the vicinity of the trailing edge 10b, but does not include a part of the suction surface 10c which extends to the trailing edge 10b. The external surface of the second metal plate 12 constitutes the entire pressure surface 10d on the pressure side which extends from the leading edge 10a to the trailing edge 10b, and constitutes a part of the suction surface 10c on the suction side which extends to the trailing edge 10b. The first joining portion 13 joins end portions on the leading edge 10a side of both metal plates to each other. The first joining portion 13 is a portion formed by brazing or welding. The second joining portion 14 joins an end portion on the trailing edge 10b side of the first metal plate 11 and a portion of the second metal plate 12 which is away from the trailing edge 10b to the leading edge 10a side. The second joining portion 14 is a portion formed by brazing or welding. The hollow portion 10e is defined by the inner surface of the first metal plate 11 which is on an opposite side from the external surface of the first metal plate 11 (suction surface 10c on the suction side) and faces the second metal plate 12 side, the inner surface of the second metal plate 12 which is on an opposite side from the external surface of the second metal plate 12 (pressure surface 10d on the pressure side) and faces the first metal plate 11 side, the first joining portion 13 on the leading edge 10a side, and the second joining portion 14 on the trailing edge 10b side.

As shown in FIG. 3, the steam turbine according to the present embodiment has a stator blade heating system 20 that heats the stator blade 10 in a hollow shape. The present stator blade heating system 20 includes: an electromagnetic coil 21 disposed within the hollow portion 10e of the stator blade 10; and a heating device 22 electrically connected to the electromagnetic coil 21 via wiring 23. The stator blade heating system 20 obviates a need for structures on the blade surface of the stator blade 10 such as slits, through holes, or the like communicating with the hollow portion 10e.

The electromagnetic coil 21, for example, has a connector 21a connectable to a connector 23a on the wiring 23 side. The heating device 22 functions as an alternating-current power supply that supplies an alternating current of a high frequency to the electromagnetic coil 21. The electromagnetic coil 21 generates a high frequency magnetic flux by being supplied with the alternating current of the high frequency from the heating device 22, and induces an eddy current by the high frequency magnetic flux in the stator blade 10 as a conductor to be heated. When the eddy current is induced in the stator blade 10, heat is generated in the stator blade 10 and the stator blade 10 rises in temperature (induction heating). The heating device 22 is disposed on the outside of the casing 2.

As shown in FIG. 3 and FIG. 4, a core 24 is disposed within the hollow portion 10e of the stator blade 10 together with the electromagnetic coil 21. The core 24 is wound with the electromagnetic coil 21. The core 24 converges and amplifies a magnetic flux generated by the electromagnetic coil 21. The core 24 can also be configured to heat the stator blade 10 from the inside using itself heated by the eddy current induced due to the high frequency magnetic flux generated by the electromagnetic coil 21. The core 24 is, for example, disposed at the position of an outer end portion (outer circumferential side end portion) in the radial direction of the steam turbine (span direction S) in the stator blade 10. The core 24 may be disposed at a position corresponding to a region where waterdrops are accumulated on the blade surface of the stator blade 10.

A thermocouple as a temperature sensor 25 that detects the temperature of the stator blade 10 is attached on an inner surface within the hollow portion 10e of the stator blade 10. The temperature sensor 25 is electrically connected to a regulator 26. The temperature sensor 25 outputs the detected temperature of the stator blade 10 to the regulator 26. The temperature sensor 25 is, for example, disposed in the vicinity of the core 24.

The regulator 26 is electrically connected to the heating device 22. The regulator 26 controls the temperature of the stator blade 10 by regulating the output of the alternating current of the heating device 22 on the basis of the temperature detected by the temperature sensor 25. The regulator 26 is disposed on the outside of the casing 2, and is separate from a controller that controls the operation of the steam turbine.

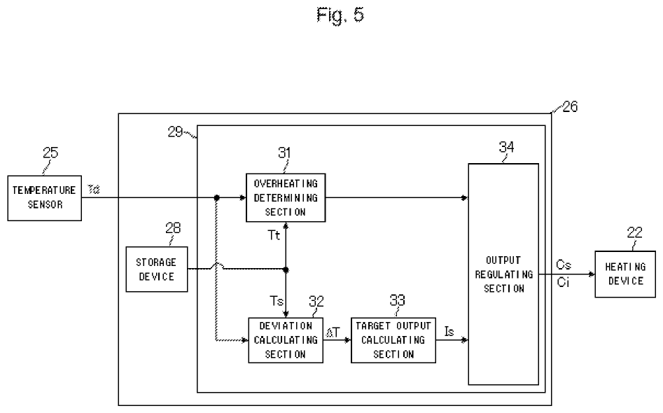

Referring to FIG. 5, description will next be made of a hardware configuration and functions of the regulator constituting a part of the stator blade heating system according to one embodiment of the present invention. FIG. 5 is a block diagram showing functions of the regulator constituting a part of the stator blade heating system according to one embodiment of the present invention, the stator blade heating system being shown in FIG. 3.

In FIG. 5, the regulator 26 performs feedback control on the basis of a temperature Td detected by the temperature sensor 25 such that the temperature of the stator blade 10 (see FIG. 3) to be heated is within a predetermined range. Proportional integral derivative (PID) control, for example, is adopted as the feedback control.

The regulator 26 includes, as a hardware configuration, for example, a storage device 28 including a random access memory (RAM), a read only memory (ROM), and the like and a processing device 29 including a central processing unit (CPU), a micro processing unit (MPU), or the like. The storage device 28 stores, in advance, a program and various kinds of information necessary for the temperature control on the stator blade 10. The processing device 29 implements the following various kinds of functions by reading the program and the various kinds of information from the storage device 28 as appropriate, and performing processing according to the program.

The regulator 26 includes an overheating determining section 31, a deviation calculating section 32, a target output calculating section 33, and an output regulating section 34 as functional sections implemented by the processing device 29.

The overheating determining section 31 captures the detected temperature Td of the stator blade 10 from the temperature sensor 25, and determines whether or not the detected temperature Td is equal to or lower than a threshold value Tt set in advance. When the detected temperature Td is equal to or lower than the threshold value Tt, the overheating determining section 31 determines that the heating of the stator blade 10 is in a normal state, and outputs the normal state as a result of the determination to the output regulating section 34. When the detected temperature Td exceeds the threshold value Tt, on the other hand, the overheating determining section 31 determines that the heating of the stator blade 10 is in an overheating state as an abnormal state, and outputs the overheating state as a result of the determination to the output regulating section 34. The threshold value Tt is stored in the storage device 28 in advance, and is a temperature for preventing degradation of the stator blade 10 from being caused by heating the stator blade 10 more than necessary.

The deviation calculating section 32 captures the detected temperature Td of the stator blade 10 from the temperature sensor 25, and calculates a temperature deviation ΔT, which is obtained by subtracting the detected temperature Td from a target temperature Ts set in advance. The target temperature Ts is stored in the storage device 28 in advance, and is a temperature that can evaporate waterdrops and a liquid film adhering to the blade surface of the stator blade 10.

The target output calculating section 33 calculates a target current value Is (target output value) of the alternating current of the heating device 22 on the basis of the temperature deviation ΔT as a result of the calculation of the deviation calculating section 32. The target output calculating section 33 is, for example, formed by a PID controller including a proportional term, an integral term, and a derivative term. The target output calculating section 33 outputs the target current value Is as a result of the calculation to the output regulating section 34.

When the determination result of the overheating determining section 31 is the overheating state, the output regulating section 34 outputs, to the heating device 22, an output stop command Cs to stop the output of the heating device 22. When the determination result of the overheating determining section 31 is the normal state, on the other hand, the output regulating section 34 outputs, to the heating device 22, an output command Ci to output the target current value Is as the calculation result of the target output calculating section 33.

Of the functional sections of the regulator 26, the overheating determining section 31 and the output regulating section 34 functions as a safety functional section that prevents an excessive rise in temperature of the stator blade 10. In addition, the deviation calculating section 32, the target output calculating section 33, and the output regulating section 34 functions as a feedback control section that performs feedback control such that the temperature of the stator blade 10 is within the predetermined range.

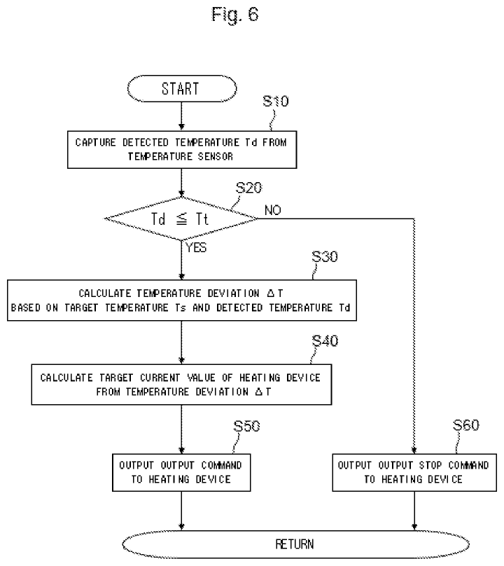

Referring to FIG. 6, description will next be made of a procedure for temperature control on the stator blade by the regulator constituting a part of the stator blade heating system according to one embodiment of the present invention. FIG. 6 is a flowchart illustrating an example of a procedure for temperature control by the regulator constituting a part of the stator blade heating system, which is shown in FIG. 5, according to one embodiment of the present invention.

In FIG. 6, the regulator 26 first captures data on the temperature of the stator blade 10 which is detected by the temperature sensor 25 (step S10).

Next, the overheating determining section 31 of the regulator 26 determines whether or not the captured detected temperature Td is equal to or lower than the threshold value Tt stored in the storage device 28 in advance (step S20). When the detected temperature Td is equal to or lower than the threshold value Tt (case of YES), the regulator 26 proceeds to step S30. Otherwise, that is, when the detected temperature Td exceeds the threshold value Tt (case of NO), the regulator 26 proceeds to step S60.

When YES is determined in step S20, the deviation calculating section 32 of the regulator 26 calculates the temperature deviation ΔT by subtracting the detected temperature Td described above from the target temperature Ts stored in the storage device 28 in advance (step S30). Next, the target output calculating section 33 of the regulator 26 calculates the target current value Is of the heating device 22 on the basis of the temperature deviation ΔT as the calculation result of the deviation calculating section 32 (step S40). Next, the output regulating section 34 of the regulator 26 outputs, to the heating device 22, the output command Ci to output the target current value Is as the calculation result of the target output calculating section 33 (step S50). Thus, the heating device 22 supplies a high frequency current of the target current value Is to the electromagnetic coil 21 on the basis of the output command Ci.

After performing the procedure of step S50, the regulator 26 returns to a start. Thereafter, the regulator 26 repeatedly performs the procedure of steps S10 to S50 unless NO is determined in step S20.

When NO is determined in step S20, on the other hand, the output regulating section 34 of the regulator 26 outputs, to the heating device 22, the output stop command Cs to stop the output of the heating device 22 (step S60). Thus, the heating device 22 stops the supply of the alternating current to the electromagnetic coil 21 on the basis of the output stop command Cs.

Referring to FIG. 1 and FIG. 3, description will next be made of actions and effects of the stator blade heating system according to one embodiment of the present invention and the steam turbine having the same. In FIG. 1, thick arrows indicate flows of steam.

In the steam turbine according to the present embodiment, as shown in FIG. 1, high-temperature and high-pressure steam introduced into the annular flow passage P passes from a first stage to a final stage in order. At this time, the thermal energy of the steam is converted into rotational energy of the turbine rotor 1, and the temperature and pressure of the steam is thereby decreased. Therefore, the steam passing through turbine stages on a downstream side is in a state of wet steam containing minute waterdrops. In particular, the minute waterdrops tend to be generated in the vicinity of the final stage located on a most downstream side.

In a conventional steam turbine, many of the minute waterdrops contained in the steam in a wet state pass between the blades of a stator blade cascade together with the steam. However, a part of the minute waterdrops adhere to the blade surfaces of the stator blades. In addition, on a part at a lower temperature than the wet steam in the blade surfaces of the stator blades, waterdrops may be generated by condensation of the steam due to supercooling. When such waterdrops on the blade surfaces of the stator blades are accumulated, a liquid film is formed. When the liquid film moves to the vicinity of the trailing edges of the stator blades by the flow of the steam and scatters into the flow of the steam, the liquid film may be flowed down as a large waterdrop. This large waterdrop causes erosion on the surfaces of a stationary member and rotor blades rotating at high speed on the downstream side of the stator blades by colliding with the stationary member and the rotor blades.

As one of conventional measures to suppress erosion, a structure is known in which slits communicating with a hollow portion are provided on the blade surface of a stator blade having a hollow structure, and the hollow portion of the stator blade communicates with a low-pressure section such as an exhaust chamber or the like. In this structure, waterdrops adhering to or condensed on the blade surface of the stator blade are removed by being sucked via the slits into the hollow portion of the stator blade.

However, because a drill or electric discharge machining is generally used for processing slits on a blade material, processing accuracy is low and cost tends to be high. In addition, there is a problem of less flexibility in arrangement of the slits. This is because, from a viewpoint of the strength of the stator blade, the slits need to be arranged intermittently, and it is difficult to process the slits in a thin portion in the vicinity of the trailing edge of the stator blade.

as another conventional measure to suppress erosion, a structure is known in which high-temperature steam is allowed to circulate in the hollow portion of the stator blade having a hollow structure. This measure is intended to evaporate waterdrops adhering to the blade surface of the stator blade and suppress condensation of the steam on the blade surface by heating the stator blade from the inside by the high-temperature steam.

However, this measure necessitates large-scale equipment such as a supply line for supplying the heated steam to the stator blade, a control valve for controlling an amount of the steam, and the like. In addition, the temperature and flow rate of the steam as a heating source for the stator blade depend on a supply source of the steam. Hence, in order to supply the stator blade with the heated steam at a fixed temperature and a fixed flow rate, consideration needs to be given to securing an appropriate supply source, maintaining the temperature of piping, and the like. These may invite complication of the heating system. Depending on the secured supply source, additional equipment for adjusting the steam temperature may be necessary. This may invite further complication of the heating system. Further, when the flow rate of the steam supplied to the stator blade is adjusted by the control valve, an actual response delay of the control valve may cause a disadvantage of an extra consumption of the heated steam.

In the present embodiment, on the other hand, as shown in FIG. 3, a high frequency current is supplied from the heating device 22 to the electromagnetic coil 21 disposed within the hollow portion 10e of the stator blade 10 during operation of the steam turbine. A high frequency magnetic flux thereby penetrates the stator blade 10 as a conductor. Therefore, an eddy current as a high density current is induced in the stator blade 10, so that the stator blade 10 is heated (induction heating). The temperature of the blade surface of the stator blade 10 thereby rises. Thus, many of waterdrops adhering to the blade surfaces 10c and 10d of the stator blade 10 can be evaporated, and the wet steam can be prevented from being condensed on the blade surfaces 10c and 10d. Therefore, the occurrence of large waterdrops scattered from the stator blade 10 can be suppressed. It is consequently possible to suppress erosion caused in the rotor blades 6 and the stationary member located on the downstream side of the stator blade 10.

The stator blade heating system 20 for heating the stator blade 10 has the electromagnetic coil 21 and the heating device 22 as a basic configuration. Hence, the present stator blade heating system 20 obviates a need for large-scale equipment as in the conventional technology such as a steam supply line, a control valve, and the like for heating the stator blade 10, and is thus a simple system as compared with the conventional technology. In addition, in the present stator blade heating system 20, structures for removing waterdrops such as the slits as in the conventional technology or the like do not need to be processed on the blade surfaces 10c and 10d of the stator blade 10 having a hollow structure. Correspondingly, the structure of the stator blade 10 is simplified, and the manufacturing of the stator blade 10 is made easier.

In addition, in the present embodiment, the stator blade heating system 20 heats the stator blade 10 by supplying a high frequency current to the electromagnetic coil 21 from the heating device 22. Therefore, starting and stopping of the heating of the stator blade 10 can be controlled by turning ON or OFF the output of the heating device 22. Hence, as compared with a configuration that controls an amount of supply of the heated steam by opening and closing the control valve in the system of the conventional technology that heats the stator blade by the heated steam, the heating device 22 has excellent responsiveness, and the stator blade heating system 20 does not consume energy (electric power) wastefully.

The stator blade heating system 20 according to the present embodiment is particularly suitable for the cascade of the stator blades 10 in the final stage in which erosion tends to occur. The present stator blade heating system 20 is also suitable for preventing the occurrence of corrosion (erosion) of the rotor blades 6 in an upstream stage of a low-pressure turbine in a boiling water nuclear reactor (BWR) using radioactive steam having a high wetness as a working fluid. When necessary, the present stator blade heating system 20 can also be applied to the stator blades 10 in all of the stages.

In addition, the stator blade heating system 20 according to the present embodiment can be applied to a different blade profile shape of the stator blade 10 by changing the shape of the electromagnetic coil 21 according to the blade profile shape. That is, the present stator blade heating system 20 is applicable to stator blades 10 of arbitrary blade profile shapes.

As described above, the stator blade heating system 20 according to one embodiment of the present invention is to heat the hollow stator blade 10 of the steam turbine, and includes the electromagnetic coil 21 disposed within the hollow portion 10e of the stator blade 10 and the heating device 22 electrically connected to the electromagnetic coil 21 and capable of supplying an alternating current to the electromagnetic coil 21.

According to this configuration, the stator blade 10 can be heated with an eddy current induced by supplying a high frequency current to the electromagnetic coil 21 disposed within the hollow portion 10e of the stator blade 10. It is therefore possible to evaporate waterdrops adhering to the blade surfaces 10c and 10d of the stator blade 10, and prevent waterdrops from being generated on the blade surfaces 10c and 10d due to the condensation of the steam. In this case, structures for removing waterdrops such as slits or the like do not need to be processed on the stator blade 10 having a hollow shape, and there is no need for large-scale equipment for supplying heated steam to the hollow portion 10e of the stator blade 10. That is, it is possible to facilitate the manufacturing of the stator blade 10, and suppress erosion without using large-scale equipment.

In addition, the stator blade segment 3a according to one embodiment of the present invention is one of a plurality of structures into which the annular nozzle diaphragm 3 obtained by coupling a plurality of hollow stator blades 10 arranged in the circumferential direction is divided in the circumferential direction, and the electromagnetic coil 21 electrically connectable to the heating device 22 capable of outputting an alternating current is disposed within the hollow portion 10e of the stator blade 10.

According to this configuration, the stator blade 10 can be heated with an eddy current induced by merely supplying a high frequency current to the electromagnetic coil 21 disposed within the hollow portion 10e of the stator blade 10. It is therefore possible to evaporate waterdrops adhering to the blade surfaces 10c and 10d of the stator blade 10, and prevent waterdrops from being generated on the blade surfaces 10c and 10d due to the condensation of the steam. In this case, structures for removing waterdrops such as slits or the like do not need to be processed on the stator blade 10 having a hollow shape, and there is no need for large-scale equipment for supplying heated steam to the hollow portion 10e of the stator blade 10. That is, it is possible to facilitate the manufacturing of the stator blade 10, and suppress erosion without using large-scale equipment.

In addition, the stator blade heating system 20 according to one embodiment of the present invention further includes the core 24 disposed within the hollow portion 10e of the stator blade 10 and wound with the electromagnetic coil 21. In the stator blade segment 3a according to one embodiment of the present invention, the core 24 wound with the electromagnetic coil 21 is disposed within the hollow portion 10e of the stator blade 10.

According to this configuration, the core 24 can converge and amplify a magnetic flux generated by the electromagnetic coil 21. Thus, the temperature of the blade surfaces 10c and 10d in a part corresponding to the position of the core 24 in the stator blade 10 can be efficiently raised more than in other parts. Hence, waterdrops on the blade surfaces 10c and 10d at the position can be further evaporated, and the generation of waterdrops on the blade surfaces 10c and 10d at the position due to the condensation of the steam can be further suppressed. In addition, since the temperature of the stator blade 10 can be raised efficiently, it is also possible to reduce power consumption of the heating device 22.

In addition, in the stator blade heating system 20 and the stator blade segment 3a according to one embodiment of the present invention, the core 24 is disposed at the position of an outer end portion in the radial direction of the steam turbine (outer circumferential side end portion) in the stator blade 10.

According to this configuration, the blade surfaces 10c and 10d of the outer circumferential side end portion of the stator blade 10 are heated more than other parts. Thus, waterdrops adhering to the position on the blade surfaces 10c and 10d can be evaporated more, and the generation of waterdrops on the blade surfaces 10c and 10d at the position due to the condensation of the steam by supercooling can be further suppressed. An outer circumferential side end portion (tip) of a rotor blade 6 has a relatively high speed in the circumferential direction than an inner circumferential side end portion (root) thereof, and is thus in an environment in which erosion occurs correspondingly easily. By further suppressing the generation of waterdrops on the blade surfaces 10c and 10d of the outer circumferential side end portion of the stator blade 10, it is possible to further suppress collision of large waterdrops against the outer circumferential side end portion (tip) of the rotor blade 6 on the downstream side of the stator blade 10, and thus further suppress erosion.

Incidentally, in the present embodiment, the core 24 can also be disposed at a position corresponding to a region where waterdrops are accumulated on the blade surfaces 10c and 10d of the stator blade 10. It is thereby possible to heat the region where waterdrops are accumulated in a concentrating manner. Large waterdrops scattered from the stator blade 10 can therefore be further suppressed. As a result, erosion of the rotor blades 6 and the stationary member located on the downstream side of the stator blade 10 can be further suppressed.

In addition, the stator blade heating system 20 according to one embodiment of the present invention further includes the regulator 26 that regulates the output of the alternating current of the heating device 22 and the temperature sensor 25 that detects the temperature of the stator blade 10. The regulator 26 regulates the output of the heating device 22 on the basis of the temperature detected by the temperature sensor 25.

According to this configuration, the regulator 26 can control the temperature of the stator blade 10 via the heating device 22. The temperature of the stator blade 10 can therefore be maintained at an appropriate temperature. Hence, reliability of the stator blade 10 can be ensured.

In addition, in the stator blade heating system 20 according to one embodiment of the present invention, the regulator 26 is configured to perform feedback control of the output of the heating device 22 such that the temperature Td detected by the temperature sensor 25 is within the predetermined range.

According to this configuration, the temperature of the stator blade 10 is maintained at an appropriate temperature by the feedback control of the regulator 26. It is therefore possible to reliably suppress the generation of large waterdrops scattered from the stator blade 10 while suppressing power consumption of the heating device 22.

In addition, in the stator blade heating system 20 according to one embodiment of the present invention, the regulator 26 is configured to stop the output of the heating device 22 when the temperature Td detected by the temperature sensor 25 exceeds the threshold value Tt set in advance.

According to this configuration, degradation and damage of the stator blade 10 due to excessive heating can be prevented, and the safety of the stator blade heating system 20 can be improved.

In addition, in the stator blade heating system 20 according to one embodiment of the present invention, the temperature sensor 25 is a thermocouple attached on the inner surface of the stator blade 10.

According to this configuration, the temperature of the stator blade 10 can be detected by a simple configuration and structure. Thus, the cost of the present system 20 can be suppressed.

In addition, as described above, the steam turbine according to one embodiment of the present invention has the stator blade heating system 20. It is therefore possible to facilitate the manufacturing of the stator blade 10, and suppress erosion without using large-scale equipment.

In addition, as described above, a stator blade heating method according to one embodiment of the present invention is to heat the hollow stator blade 10 of the steam turbine, and includes: supplying an alternating current to the electromagnetic coil 21 disposing within the hollow portion 10e of the stator blade 10; detecting the temperature of the stator blade 10; and regulating the output of the alternating current to the electromagnetic coil 21 on the basis of the detected temperature Td.

According to this method, the stator blade 10 can be heated with an eddy current induced by supplying a high frequency current to the electromagnetic coil 21 within the hollow portion 10e of the stator blade 10. It is therefore possible to evaporate waterdrops adhering to the blade surfaces 10c and 10d of the stator blade 10, and prevent waterdrops from generating on the blade surfaces 10c and 10d due to the condensation of the steam. In this case, structures for removing waterdrops such as slits or the like do not need to be processed on the stator blade 10 having a hollow shape, and there is no need for large-scale equipment for supplying heated steam to the hollow portion 10e of the stator blade 10. That is, it is possible to facilitate the manufacturing of the stator blade 10, and suppress erosion without using large-scale equipment. Further, the temperature of the stator blade 10 can be controlled by regulating the output of the current supplied to the electromagnetic coil 21. Thus, the temperature of the stator blade 10 can be maintained at an appropriate temperature. Hence, reliability of the stator blade 10 can be ensured.

### Other Embodiments

It is to be noted that the present invention is not limited to the foregoing one embodiment, and includes various modifications. The foregoing embodiment is described in detail to describe the present invention in an easily understandable manner, and is not necessarily limited to including all of the described configurations.

For example, while a steam turbine in which two low-pressure turbines are connected in tandem with each other has been described as an example in the foregoing one embodiment, the present invention is applicable to steam turbines of optional structures including stator blades in a hollow shape among steam turbines in which erosion occurs.

In addition, the foregoing one embodiment illustrates an example of a configuration in which the stator blade heating system 20 includes the core 24. However, a stator blade heating system of a configuration in which only the electromagnetic coil 21 is disposed in the hollow portion 10e of the stator blade 10 is also possible. Also in this case, the stator blade 10 can be heated with an eddy current induced by supplying a high frequency current from the heating device 22 to the electromagnetic coil 21 disposed within the hollow portion 10e of the stator blade 10. It is therefore possible to evaporate waterdrops on the blade surfaces 10c and 10d of the stator blade 10, and suppress the generation of waterdrops on the blade surfaces 10c and 10d due to condensation.

In addition, the foregoing one embodiment illustrates an example in which each stator blade segment 3a constituting the nozzle diaphragm 3 is formed by a plurality of stator blades 10 and the divided outer ring portion 8a and the divided inner ring portion 9a in an arcuate shape which couple those stator blades 10 to one another. However, a configuration is also possible in which each stator blade segment is formed by one stator blade 10 and a divided outer ring portion and a divided inner ring portion in an arcuate shape which are provided to both ends in the span direction S of the stator blade 10.

In addition, the foregoing one embodiment illustrates an example of a configuration in which the regulator 26 regulates the output of the heating device 22. However, a configuration is also possible in which a controller that controls the operation of the steam turbine regulates the output of the heating device 22.

In addition, the foregoing one embodiment illustrates an example of a configuration in which a thermocouple is used as the temperature sensor 25. However, a configuration is also possible in which a radiation thermometer is used as the temperature sensor 25

What is claimed is:

1. A stator blade heating system for heating a hollow stator blade of a steam turbine, the stator blade heating system comprising:
an electromagnetic coil disposed within a hollow portion of the stator blade; and
a heating device electrically connected to the electromagnetic coil and capable of supplying an alternating current to the electromagnetic coil.

2. The stator blade heating system according to claim 1, further comprising:
a core disposed within the hollow portion of the stator blade and wound with the electromagnetic coil.

3. The stator blade heating system according to claim 2, wherein the core is disposed at a position of an outer end portion in a radial direction of the steam turbine in the stator blade.

4. The stator blade heating system according to claim 1, further comprising:
a regulator that regulates output of the alternating current of the heating device; and
a temperature sensor that detects a temperature of the stator blade, wherein
the regulator is configured to regulate the output of the heating device on a basis of the temperature detected by the temperature sensor.

5. The stator blade heating system according to claim 4, wherein
the regulator is configured to perform feedback control of the output of the heating device such that the temperature detected by the temperature sensor is within a predetermined range.

6. The stator blade heating system according to claim 4, wherein
the regulator is configured to stop the output of the heating device when the temperature detected by the temperature sensor exceeds a threshold value set in advance.

7. The stator blade heating system according to claim 4, wherein
the temperature sensor is a thermocouple, the thermocouple being attached on an inner surface of the stator blade.

8. A steam turbine comprising the stator blade heating system according to claim 1.

9. A stator blade segment being one of a plurality of structures into which an annular nozzle diaphragm is divided in the circumferential direction, the annular nozzle diaphragm being formed by coupling a plurality of hollow stator blades arranged in a circumferential direction, the stator blade segment comprising:
an electromagnetic coil disposed within a hollow portion of the stator blade, the electromagnetic coil being electrically connectable to a heating device configured to output an alternating current.

10. The stator blade segment according to claim 9, wherein
a core wound with the electromagnetic coil is disposed within the hollow portion of the stator blade.

11. The stator blade segment according to claim 10, wherein
the core is disposed at a position of an outer circumferential side end portion in the stator blade.

12. A stator blade heating method of heating a hollow stator blade of a steam turbine, the stator blade heating method comprising:
supplying an alternating current to an electromagnetic coil disposed within a hollow portion of the stator blade;
detecting a temperature of the stator blade; and
regulating output of the alternating current to the electromagnetic coil on a basis of the detected temperature.

13. The stator blade heating method according to claim 12, wherein
the output of the alternating current to the electromagnetic coil is regulated such that the detected temperature is within a predetermined range.

14. The stator blade heating method according to claim 12, wherein
the supply of the alternating current to the electromagnetic coil is stopped when the detected temperature exceeds a threshold value set in advance.
